(19) United States
(12) Patent Application Publication
(10) Pub. No.: US 2012/0076299 A1
(43) Pub. Date: Mar. 29, 2012

(54) Method for the encrypted transmission of data from a mobile date storage device to a stationary device as well as data encryption adapter

(76) Inventor: Oliver Koemmerling, Monaco (MC)

(21) Appl. No.: 13/242,750

(22) Filed: Sep. 23, 2011

Related U.S. Application Data
(60) Provisional application No. 61/387,032, filed on Sep. 28, 2010.

(30) Foreign Application Priority Data
Sep. 23, 2010 (DE) 10 2010 046 229.2

(51) Int. Cl. H04L 9/00

(52) U.S. Cl. 380/255

(57) ABSTRACT

The present invention relates to a method for the encrypted transmission of data from a mobile, first data storage device (300) to a stationary device (200, 200a, 200b) which comprises a second data storage device or a second data evaluation unit, or for preparing an encrypted transmission between the mobile, first data storage device (300) and the second data storage device, wherein the method comprises at least the following step: connecting an electric or electronic data encryption adapter (100) with the stationary device (200), wherein the data encryption adapter (100) comprises a first interface (105) which is configured for exchanging data which is encrypted by means of a first encryption algorithm with the second data storage device or a second data evaluation unit of the stationary device (200) in an encrypted way, wherein the data encryption adapter (100) is provided and/or configured and/or designed for intaking the mobile, first data storage device (300) or for transmitting data with the mobile, first data storage device (300), and wherein the data encryption adapter (100) comprises a second interface (107) which is provided for exchanging data which was encrypted by means of a second encryption algorithm with the mobile, first data storage device (300); wherein connecting the data encryption adapter (100) with the stationary device (200) encompasses establishing a data exchange connection between the data encryption adapter (100) and the second data storage device or the second data evaluation unit of the stationary device (200) for data which was encrypted by means of a first data encryption algorithm. The invention further relates to a data encryption adapter (100).

The present invention relates to a method for encrypted transmission of data from a mobile, first data storage device to a stationary device according to claim 1. It further relates to a data encryption adapter according to claim 6 or 7.

Encryption algorithms of mobile data storage devices for topping up or increasing credit on stationary devices such as electronic power meters, as are common in the United Kingdom and several other countries, are prone to the risk of being decrypted by unauthorized persons. Misusing the knowledge of the encryption algorithm may enable topping up credit on the stationary devices such as the power meter without a corresponding pay having taken place at the proper places or authorities.

One object of the present invention is to propose a method for the encrypted transmission of data (again) from a mobile, first data storage device to a stationary device by using a data encryption adapter. Furthermore, a corresponding data encryption adapter is to be proposed.

This object is accomplished by means of a method with the features of claim 1. It is further accomplished by means of a data encryption adapter with the features of claim 6 as well as by means of a data encryption adapter with the features of claim 7.

In all of the following embodiments, the use of the expression may be or may have and so on, is to be understood synonymously with preferably is or preferably has, respectively, and so on, and is intended to illustrate an embodiment according to the invention.

The method according to the invention serves to transmit encrypted data from a mobile, first data storage device to a stationary device or to prepare an encrypted transmission between the mobile, first data storage device and the stationary device. In doing so, the stationary device may be provided to be stationary such as, e.g., screwed on and for use at always the same location. However, it is in other embodiments according to the invention—other than suggested by its name—mobile or non-stationary.

The method according to the invention includes connecting a data encryption adapter with the stationary device by establishing a data exchange connection between the data encryption adapter and the stationary device.

The data encryption adapter according to the invention is suitable and/or provided and/or configured to be used in a method according to the invention.

The data encryption adapter according to the invention is suitable and/or provided to be connected with a stationary device.

Advantageous developments of the present invention are each subject of dependent claims and embodiments.

Embodiments according to the invention may comprise one or more of the following features.

The method according to the invention serves in certain embodiments to transmit data which has been encrypted by means of a second encryption algorithm from a mobile, first data storage device to the data encryption adapter, in order to transmit this data which has been subsequently encrypted with a first encryption algorithm from the data encryption adapter to the stationary device or a second data storage device or a second data evaluation unit of the stationary device.

The data encryption adapter—which is in some embodiments according to the invention embodied as being electric or electronic—comprises in certain embodiments a first interface which is configured for encrypted exchange or transmission of data which is encrypted by means of a first encryption algorithm with or to the second data storage device or a second data evaluation unit of the stationary device.

The data encryption adapter is in certain embodiments provided and/or configured and/or embodied for intaking the mobile, first data storage device or a section hereof.

In some embodiments according to the invention, the data encryption adapter is provided and/or configured and/or embodied as an integral or one-piece constituent of a part (or component or element) of the stationary device, or it is a detachable part hereof or a part hereof which cannot be detached without destroying it.

This part (component, element, and so on) of the stationary device is in certain embodiments according to the invention a screen for example a front cover or a side cover, of the stationary device, an attachment, an upper or lower cover of the stationary device, or the like.

The data encryption adapter may thus also be connected with the stationary device by adding a further component, in particular in a non-detachable way, to the stationary device or by replacing the component concerned with a different one. Hereby, the further component, which ultimately remains on the stationary device, carries or encompasses the data encryption adapter.

In some embodiments, the data encryption adapter is provided and/or configured and/or embodied for data transmission with the mobile, first data storage device. Intaking the mobile, first data storage device is in certain embodiments an intaking which is effective for signal transmission, for example suitable and/or provided for data exchange via infrared, bluetooth, WLAN, by means of electronically conducted signals or the like.

In some embodiments, the data encryption adapter comprises a second interface which is provided for exchanging data which was encrypted by means of a second encryption algorithm with the mobile, first data storage device.

In certain embodiments, connecting the data encryption adapter with the stationary device encompasses establishing or generating a preferably permanent data exchange connection between the data encryption adapter and the second data storage device or the second data evaluation unit of the stationary device for exchanging or transmitting data which was encrypted by means of a first encryption algorithm.

In certain embodiments of the present invention, the mobile, first data storage device is a customer's mobile data storage device which can be topped up. The mobile, first data storage device is in certain embodiments provided and/or configured for receiving data, where required in a suitably converted form. This is for example data which contains or reflects a credit for consumption by the customer, e.g., for electricity, phone, mobile communications or the like.

The first, mobile data storage device can be designed as a USB stick, SIM card, SD card, chip card, swipe card and the like.

In certain embodiments, the second data storage device of the stationary device is a chip, microchip, and so on.

The second data evaluation unit of the stationary device is in certain embodiments an electronic meter.

The second data storage device or the second data evaluation unit serve in certain embodiments of the present invention to receive data, i.e. information, e.g., about a credit.

In certain embodiments of the present invention, the stationary device is a meter which is mounted to the wall, e.g., in a customer's household or company, for example a power meter, a gas meter, a water meter or the like.

The first encryption algorithm may be an encryption algorithm which is or has become publicly known—for example published in an unlawful way.

The first encryption algorithm is in certain embodiments an algorithm by means of which the stationary device and the mobile, first data storage device previously communicated without data encryption adapter before it became known, and by means of which they still communicate—now, however, according to the invention by using a data encryption adapter.

The first encryption algorithm may be filed on the second data storage device and/or in the second data evaluation unit of the stationary device. The first encryption algorithm is filed on the data encryption adapter, such as for example on a storage unit or a chip, memory chip, microchip and the like of the data encryption adapter.

In preferred embodiments, the chip or the storage unit of the data encryption adapter comprises a current safety standard.

The term encryption algorithm, as is used herein in relation to the first and the second encryption algorithm, is in certain embodiments to be understood as an algorithm which is to be used both for encryption and corresponding decryption.

The concrete design of the first and/or second encryption algorithm is according to the invention not or not essentially important. A specification of concrete designs is according to the invention in fact not provided. Rather, each suitable encryption algorithm which is known to the person skilled in the art or specialist or still has to be created can be used.

The first and the second encryption algorithm are in certain embodiments encryption algorithms which are different from each other. This is desirable and of advantage in particular in cases in which an encryption algorithm—usually the first encryption algorithm—was or could be made public and, e.g., the target of attempted fraud.

In certain embodiments of the present invention, the second encryption algorithm is freely choosable from already known standard algorithms or is an encryption algorithm which will be developed in future.

The second encryption algorithm may be a new encryption algorithm, at least an encryption algorithm which is not yet known (or recognized by) or made available to the public.

The second encryption algorithm is in certain embodiments filed on the data encryption adapter (on the same or a different chip, memory chip and so on of the data encryption adapter). Besides, the second encryption algorithm is preferably also filed on the mobile, first data storage device.

The term data exchange as used herein denotes in certain embodiments of the present invention a process in which a first, in particular electric or electronic, component transmits, sends, transfers or the like data, and in which a second, in particular electric or electronic, component intakes, stores, or, as the case may be, converts this data and so on.

The term data transmission as used herein denotes in certain embodiments a data transmission, in particular a mainly unilateral data exchange, between a first and a second electric or electronic component, for example a data transmission from the mobile, first data storage device to the data encryption adapter or from the data encryption adapter to the stationary device or the second data storage device or the second data evaluation unit of the stationary device.

The transmission of the encrypted data itself may take place in an encrypted or unencrypted way. Whenever in the context of this invention there is mention of an encrypted transmission of data, the transmission itself may take place in an encrypted way, and/or encrypted data may be transmitted or exchanged in an encrypted or unencrypted way.

A data exchange or a data transmission may in certain embodiments encompass encrypting and/or decrypting and/or converting the data and the like.

In certain embodiments of the method according to the invention, the established connection of the electronic data encryption adapter with the stationary device is permanent.

The term permanent as used herein denotes in some embodiments a form-locking and/or frictional and/or firmly bonded connection of the data encryption adapter with the stationary device.

In certain embodiments of the present invention, an established connection is permanent, if it is not temporary and/or not detachable (with normal measures and/or applying little effort). In particular, a connection is permanent if it can only be detached by means of destruction.

In some embodiments of the present invention, an established connection is permanent, if it is designed to last, e.g., for the remaining time of use or remaining lifetime of the utilized components or of all components which take part in the connection.

The established connection of the data encryption adapter with the stationary device in certain embodiments of the method according to the invention takes place using an insertion opening (or slide-in opening) of the stationary device, which was intended for a mobile data storage device.

In certain embodiments of the present invention, the connection of the data encryption adapter with the stationary device takes place exclusively via the insertion opening which is provided at the stationary device.

The insertion opening is in some embodiments of the present invention the opening which was previously intended by the producer for intaking the first, mobile data storage device. According to the invention, the insertion opening is in certain embodiments now provided for intaking the data encryption adapter instead of the mobile, first data storage device.

In certain embodiments, the method according to the invention encompasses writing data which is encrypted by means of the second encryption algorithm on the mobile, first data storage device.

Writing the mobile, first data storage device takes place via a second stationary or non-stationary device which is not the first stationary device with the second data storage device or the second data evaluation unit of the stationary device.

In certain embodiments, the second—stationary or non-stationary—device is a device which is provided at a different location than the first stationary device. It may be, e.g., a top-up unit or station or device in a shop.

In certain embodiments, the second stationary or non-stationary device (top-up station) writes data on the mobile, first data storage device with the aid of a second data encryption adapter. Thus, the second data encryption adapter may be used, e.g., also at the top-up unit.

In some embodiments, the second data storage device or the second data evaluation unit of the first stationary device is an electronic power meter.

In certain embodiments, the second data storage device or the second data evaluation unit is provided in or at an electronic power meter.

The data encryption adapter according to the invention comprises in certain embodiments a first interface and a second interface.

In certain embodiments, the first interface is provided and/or configured for exchanging or transmitting data which is encrypted by means of a first encryption algorithm with or to the second data storage device or a second data evaluation unit of the stationary device in an encrypted way.

The data encryption adapter according to the invention is in certain embodiments provided and/or configured and/or designed for intaking the mobile, first data storage device and/or for data transmission with the mobile, first data storage device by means of a second encryption algorithm.

In some embodiments, the second interface is provided for receiving data from the mobile, first data storage device. The data is thereby in certain embodiments encrypted with a second encryption algorithm.

In certain embodiments, the data encryption adapter according to the invention comprises a device which is provided and/or configured for converting the data which was encrypted by means of the first encryption algorithm, into data which is or will be encrypted by means of the second encryption algorithm and/or vice versa.

In some embodiments, the data encryption adapter according to the invention comprises a device for its permanent locking and/or otherwise connection in the—only preferably—stationary device.

Locking the data encryption adapter at the stationary device is in certain embodiments an irreversible, non-detachable locking and/or a locking which is detachable only in an destructive way, i.e. by applying brute force or power, at least a locking which is not detachable by means of simple manual actions and/or with only little mechanical effort (e.g., not by simply inserting and extracting or by clipping in using a clip which is easily detachable after having snapped in and the like).

The data encryption adapter comprises in certain embodiments a device for its exclusive or supportive locking and/or otherwise connection in an insertion opening of the stationary device which is intended for a mobile data storage device.

The locking or connection is in certain embodiments irreversible or detachable only in a destructive way.

In some embodiments, the device for its connection or locking in with the stationary device is or at least comprises a clamping device, a latching device, a snapping device, a (barbed) hook device, a clamping device or the like.

In certain embodiments, the device is a mechanical clamp which snaps in as soon as the data encryption adapter is inserted into the stationary device.

The data encryption adapter may be a unit which is cast, shrink-wrapped, glued in a plastic shell and/or designed the like which is or will be embedded in or at the stationary device in a non-detachable way.

In certain embodiments, the data encryption adapter is sealed or lead-sealed at the stationary device.

In some embodiments, the device for connecting or locking is detachable from the stationary device after the data encryption adapter was connected or locked as intended in or at the stationary device only in a destructive way, at least in a detectable way (e.g., by breaking a seal or the lead-seal).

In certain embodiments of the data encryption adapter according to the invention, the first interface is provided and/or configured for exchanging data which is encrypted by means of a first encryption algorithm with the second data storage device or a second data evaluation unit of the stationary device. The data exchange may take place in an encrypted or unencrypted way.

In certain embodiments, the second interface is provided and/or configured for receiving data from a data storage device other than the second data storage device or a second data evaluation unit of the stationary device, which is encrypted by means of the second encryption algorithm.

In certain embodiments of the present invention, the data encryption adapter is provided and/or designed for data transmission with a mobile, first data storage device which is embodied as a SIM card or SD card.

In some embodiments according to the invention, the originally used second stationary or non-stationary device, which may be, for example, a top-up station, is retained unchanged. In other embodiments according to the invention, it is replaced by a different one or another second stationary or non-stationary device is used. The same applies to the mobile, first data storage device. In some embodiments according to the invention, the originally used mobile, first data storage device is retained unchanged. In other embodiments according to the invention, it is replaced by a different one or another mobile, first data storage device is used.

The present invention advantageously provides a method for transmitting encrypted data which is basically protected from unauthorized access as well as a data encryption adapter which is usable in this method.

In particular, the data encryption adapter according to the invention is advantageously applicable in cases in which in an existing data transmission system a utilized first encryption algorithm has already been made publicly known and thus can be misused.

By means of the method according to the invention using a second encryption algorithm—which in particular is unknown or not recognized by the relevant circles in which misuse takes place—, it is in certain embodiments advantageously possible to secure the previously unsafe transmission system again and decrease or even completely exclude further misuse.

By using the data encryption adapter according to the invention, it is thus advantageously possible in certain embodiments to further use an existing data transmission system which was formerly encrypted. Along with this, it is advantageously possible to keep the expenditure low for once again securing the system.

Thus, its advantageously possible by means of the method according to the invention to maintain the already existing encryption system and just add a further encryption step. The present invention thus represents in certain embodiments an advantageously uncomplicated addition which is easy to use and requires little effort to implement. A cost-intensive exchange of existing systems with completely new devices, which is often associated with enormous effort, may thus be advantageously prevented.

As the data encryption adapter according to the invention in certain embodiments is not detachable from the stationary device, it is advantageously possible to prevent access to, e.g., a credit booking system by fraudsters or to detect the unauthorized access by means of the destroyed data encryption adapter.

As electronic access to the joints between the data encryption adapter and the stationary device is only possible by removing the data encryption adapter from the stationary device with brute force, e.g., by breaking it, protection of the system from misuse can thus advantageously be ensured.

In addition, it is in certain embodiments furthermore advantageously possible to use the data encryption adapter both at a first stationary device in the household as well as at a second stationary or non-stationary device in the shop or in business. As the data encryption adapters may each be alike, the construction effort may advantageously be kept low which in turn advantageously contributes to saving costs.

Hereafter, the present invention is exemplarily described with reference to the appended figures in which identical reference numerals refer to same or similar components. In the in part highly simplified figures it applies that:

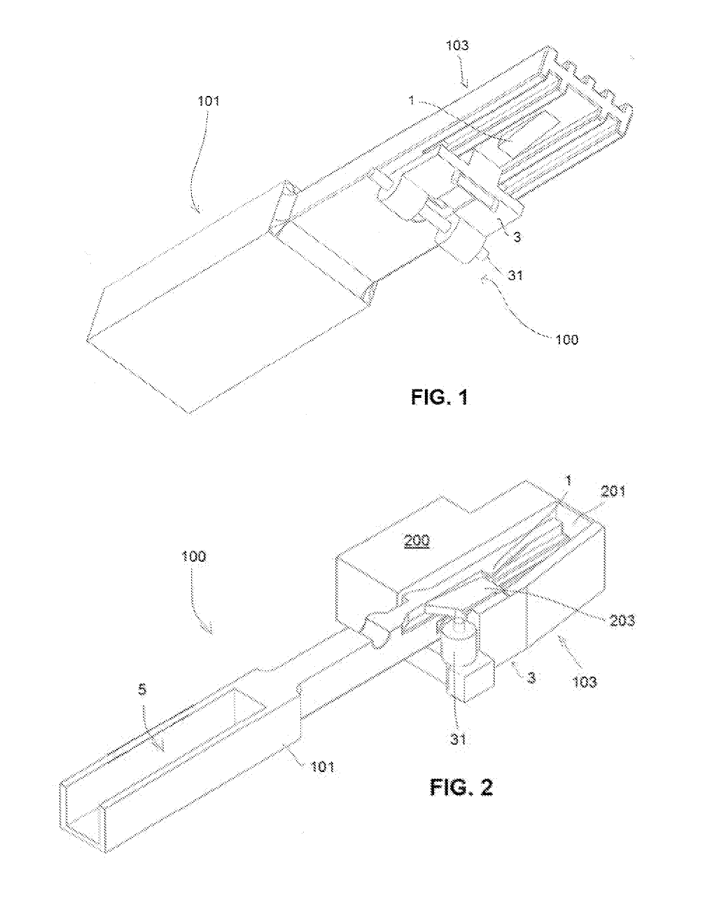

FIG. 1 schematically shows a perspective lateral view of a data encryption adapter according to the invention;

FIG. 2 shows a horizontal longitudinal section through a data encryption adapter according to the invention which is arranged at a stationary device in perspective view;

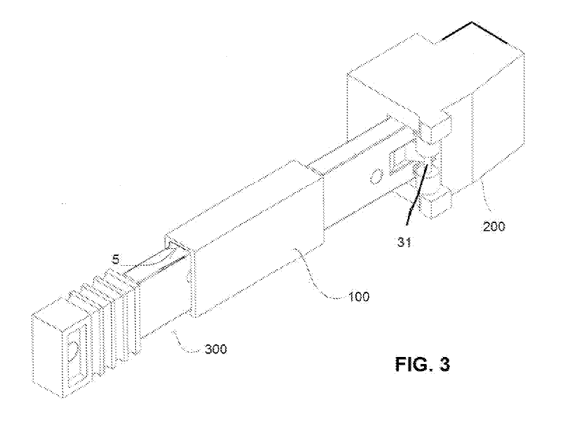

FIG. 3 shows an arrangement of a mobile, first data storage device at a data encryption adapter according to the invention, which, as in FIG. 2, is arranged at the stationary device in perspective view;

FIG. 4 shows a stationary device which comprises a data encryption adapter according to the invention as well as a mobile, first data storage device in perspective view;

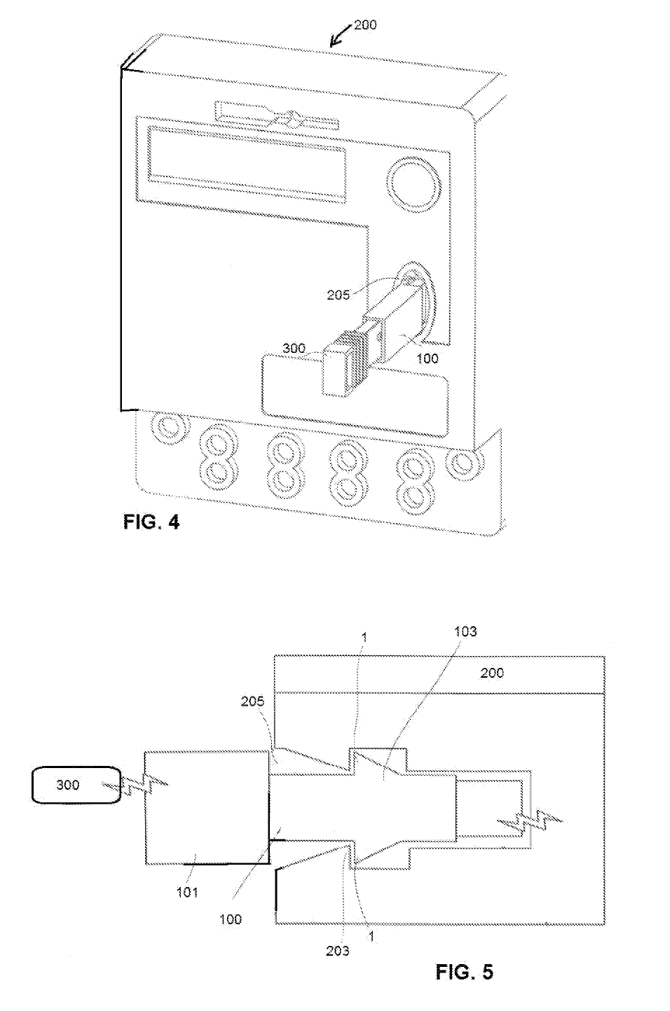

FIG. 5 illustrates in a schematically very simplified way a principle of the data transmission by means of the data encryption adapter according to the invention by means of a vertical section through a data encryption adapter according to the invention which is arranged at a stationary device;

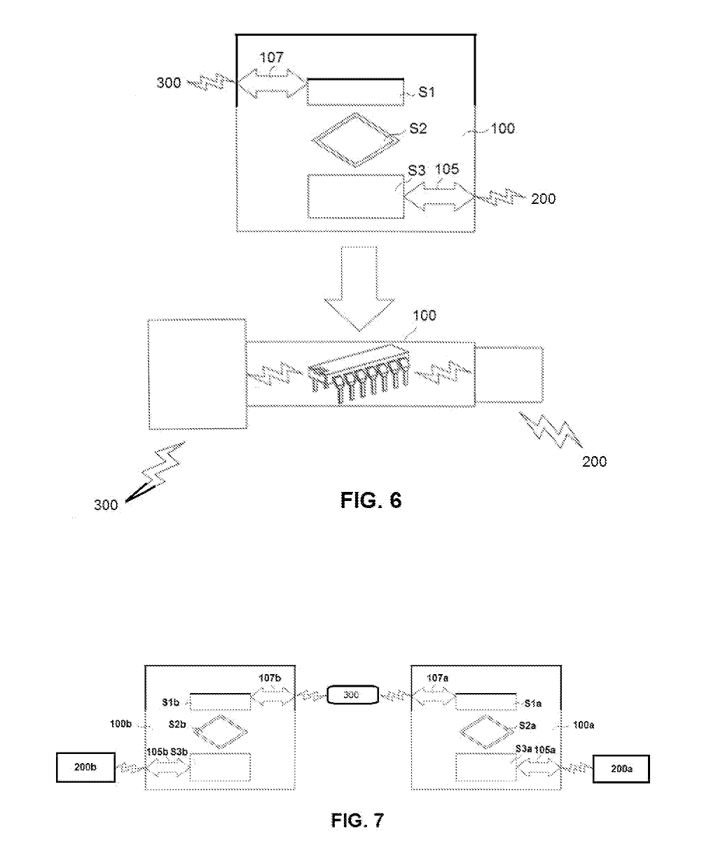

FIG. 6 schematically illustrates a method of data transmission by means of the data encryption adapter according to the invention; and

FIG. 7 illustrates a method of data transmission between a first stationary device and a second stationary device using data encryption adapters according to the invention.

FIG. 1 schematically shows a perspective lateral view of a data encryption adapter 100 according to the invention.

The data encryption adapter 100 comprises a first area 101 which is provided and/or configured and/or designed for intaking a mobile, first data storage device (not shown in FIG. 1).

The data encryption adapter 100 comprises a second area 103 which is suitable and provided and/or designed for being connected with a stationary device (also not shown in FIG. 1).

The data encryption adapter 100 comprises a first device 1 which is suitable and provided for locking the data encryption adapter 100 in the stationary device.

Also shown is a second device 3 of the stationary device which is otherwise not shown in FIG. 1. The second device 3 is designed as tipping apparatus and suitable and provided for locking the data encryption adapter 100 in an insertion opening (not shown in FIG. 1) of the stationary device which is intended for the mobile, first data storage device. For this, the second device 3 can be tipped around a tipping axis 31 which is mounted in the stationary device during use.

As already explained above, the second device 3 is, like a tipping axis 31, not necessary for connecting the data encryption adapter 100 to the stationary device. Any other connection which does not rely on the second device 3 is also encompassed by the invention. However, in certain embodiments in which the stationary device already comprises the second device 3 and/or the tipping axis 31, it may advantageously be appropriate to include these in the connection. Actually, however, any other type of connection which does not use a second device 3 or a tipping axis 31 is also encompassed by the invention. According to the invention, these connections include bonding, welding or fusing, screwing together, sealing by means of hologram and further joining methods.

FIG. 2 shows a horizontal longitudinal section through a data encryption adapter 100 according to the invention which is arranged at a stationary device 200 in perspective view. A mounting 5 which is illustrated in a U-profile-shape can be recognized which in a non-sectional view shows a closed profile. The mounting 5 serves to intake a mobile, first data storage device which is not shown in FIG. 2, for example a key.

The stationary device 200 is only partially shown in the area of the segment which is provided for intaking the data encryption adapter 100. It is also represented in a sectional view.

The stationary device 200 comprises an intake area 201 which, as shown in FIG. 2, is provided for intaking the area 103 of the data encryption adapter 100.

As can be taken from FIG. 2, the data encryption adapter 100 is undetachably arranged with the stationary device 200 after having latched in it: The data encryption adapter 100 is introduced, plugged and so on into the stationary device 200 in the area of its second area 103 such that the first device 1 for locking, e.g.,—as exemplarily shown in FIG. 2—in the form of a latching device, is arranged in a non-detachable way behind, in relation to the direction of plugging in, introducing and so on the data encryption adapter 100, a blocking device 203 of the stationary device 200.

As is shown in FIG. 2, the arrangement of the data encryption adapter 100 in or at the stationary device 200, which is non-detachable or not detachable in a non-destructive way, is done merely mechanically by means of a plug-and-snap connection. Further examples of possible other embodiments include, without being limited to it, a gluing, shrink-wrapping or welding or fusing, riveting or clenching and the like of the data encryption adapter in or at the stationary device 200 in order to establish the connection, which is preferably not detachable in a non-destructive way, of the two components, i.e. data encryption adapter 100 and stationary device 200.

FIG. 3 shows an arrangement of a mobile, first data storage device 300 at a data encryption adapter 100 in perspective view according to the invention. The data storage device 300 is inserted into the mounting 5. The data encryption adapter 100 is, as can be recognized in the illustration of FIG. 3, arranged at a stationary device 200 or locked or latched in the stationary device 200.

In the example of FIG. 3, the mobile, first data storage device 300 is embodied as a USB stick. The mobile, first data storage device may be embodied as or comprise a SIM card or SD card.

FIG. 4 shows a stationary device 200 in perspective view which comprises a data encryption adapter 100 according to the invention as well as a mobile, first data storage device 300 which is plugged into the data encryption adapter 100.

As is easy to recognize from FIG. 4, the data encryption adapter 100 according to the invention is arranged or non-detachably locked or latched in an insertion opening 205 of the stationary device 200 which was originally intended for the mobile, first data storage device 300.

The stationary device 200 may be, as is exemplarily outlined in FIG. 4, for example a power meter box as can be found in various households around the world.

FIG. 5 schematically illustrates a principle of data transmission by means of the data encryption adapter 100 according to the invention by means of a vertical section through a data encryption adapter 100 according to the invention which is arranged at a stationary device 200.

The flashes shown in FIG. 5—as well as the flashes shown hereafter in FIG. 6 and FIG. 7—indicate a data transmission between the relevant components or the possibility of such data transmission. They can be understood as the representation of one interface each.

As is shown in FIG. 5, the data encryption adapter 100 is arranged at or plugged into the stationary device 200 in a permanent and non-detachable way: First devices 1 for locking are arranged behind—in the direction of plug-in of the data encryption adapter 100 into the stationary device 200—blocking devices 203 of the stationary device 200, which are non-tippable here, such that removing, i.e. extracting the data encryption adapter 100 from the stationary device 200 or from the insertion opening 205 of the stationary device 200 cannot be done in a non-destructive way (i.e. without damages to the data encryption adapter 100, above all, however, to the stationary device 200)

An undetected unlawful removal of the data encryption adapter 100 from the stationary device 200 such that using the insertion opening and/or the electronic connections which are located in depth could become possible again can thus advantageously be safely ruled out—depending on the concrete embodiment.

The flash shown on the left in FIG. 5 indicates the data transmission between the mobile, first data storage device 300 and the data encryption adapter 100 or a contact with the second interface of the data encryption adapter 100. The flash shown on the right in FIG. 5 indicates the data transmission between the stationary device 200 and the data encryption adapter 100 or a contact with the first interface of the data encryption adapter 100.

FIG. 6 schematically illustrates a method of data transmission by means of the data encryption adapter 100 according to the invention.

The upper area of FIG. 6 schematically shows a data encryption adapter 100 with a first interface 105 and a second interface 107.

The first interface 105 serves to transmit data between the data encryption adapter 100 according to the invention and the stationary device 200 (not shown in FIG. 6).

The second interface 107 serves the transmission of data between the data encryption adapter 100 according to the invention and the mobile, first data storage device 300 (not shown in FIG. 6).

The data transmission between the mobile, first data storage device 300 and the data encryption adapter 100 takes place by using a second encryption algorithm. The second encryption algorithm is preferably a new encryption algorithm, in particular an encryption algorithm which was developed for protecting the data transmission from unauthorized access.

In certain embodiments according to the invention, the second encryption algorithm differs from the first encryption algorithm. The differentiation is in some embodiments according to the invention such that data which was encrypted by means of the first encryption algorithm cannot be decrypted with the second encryption algorithm or its decryption counterpart, or vice versa.

The data encrypted with the second encryption algorithm is filed on the mobile, first data storage device 300. By means of the second interface 107, the data encrypted with the second encryption algorithm are transmitted to the data encryption adapter 100 according to the invention.

The data encryption adapter 100 according to the invention receives the data transmitted from the mobile, first data storage device 300 (step S1).

In a step S2, the data encryption adapter 100 decrypts the data encrypted with the second encryption algorithm and evaluates the information filed in the data, e.g., an amount of money for a certain power consumption quota.

Further, the data encryption adapter 100 encrypts the data in step S2 with a first encryption algorithm. The first encryption algorithm may be an encryption algorithm which has already become known or which was decrypted in an unauthorized way.

In step S3, the data encryption adapter 100 according to the invention transmits the data encrypted with the first encryption algorithm to the stationary device 200 via the first interface 105.

In embodiments in which the stationary device 200 is embodied as power meter, the method according to the invention of encrypted data transmission serves to top up or increase a meter reading, in particular a power meter reading.

In the lower area of FIG. 6, the transmission function of the data encryption adapter 100 according to the invention is again schematically illustrated. The flashes indicate again one data transmission process each between the mobile, first data storage device 300 and the stationary device 200.

FIG. 7 illustrates a method of data transmission between a first stationary device 200a and a second stationary device 200b using the data encryption adapter 100 according to the invention or several copies hereof.

The second stationary device 200b is for example a top-up station in a shop which is provided for topping up the first, mobile data storage device 300. The top-up station serves to encrypt writing of data which corresponds to, e.g., a credit (power consumption, mobile phone use, and so on) on the first, mobile data storage device 300. Encryption takes place by means of the second encryption algorithm.

The first stationary device 200a is for example a power meter in a household.

The method according to the invention is not at all limited to a use for topping up/increasing a power quota. Rather, it may be used for any conceivable purpose of increasing a credit on a first stationary device 200a which is located on or arranged at second (stationary or non-stationary) device 200b.

Hereafter, a top-up process of a power meter with a credit for the power consumption of a household is—merely exemplarily—described.

A first data encryption adapter 100a is provided at a first stationary device 200a and in particular locked in it in a non-detachable way. For example, the first data encryption adapter 100a is arranged together with a first stationary device 200a in a private household—in the scope of the example described in FIG. 7.

A second data encryption adapter 100b is provided at a second stationary device 200b. Here, it is irrelevant whether the connection is detachable or non-detachable. Both are encompassed by the invention. For example, the second data encryption adapter 100b and the second stationary device 200b are—in the scope of the example described in FIG. 7—arranged in a shop.

The mobile, first data storage device 300 is movable in a mobile way between the first stationary device 200a and the second stationary device 200b, for example it can be carried along by a customer for top-up purposes.

For topping up the mobile, first data storage device 300, it is taken to the second stationary device 200b by the customer.

The mobile, first data storage device 300 is introduced into the second data encryption adapter 100b which is arranged at the second stationary device 200b.

The data which is associated with a certain credit (as desired by the customer; for example manually entered into the second stationary device 200b via a keyboard) is encrypted in the second stationary device 200b with a first encryption algorithm.

The data encrypted with the first encryption algorithm are transmitted to the second data encryption adapter 100b via a first interface 105b of the second data encryption adapter 100b. The second data encryption adapter 100b receives in step S3b the data of the second stationary device 200b.

In step S2b, the second data encryption adapter 100b decrypts the data encrypted with the first encryption algorithm and encrypts the data with a second encryption algorithm (which is not publicly known).

In step S1b, the data encrypted with the second encryption algorithm is transmitted to the mobile, first data storage device 300 via the second interface 107b of the second data encryption adapter 100b. The first data storage device 300 is hereby plugged into the second data encryption adapter 200b for data transmission or connected for data transmission with the second data encryption adapter 200b in another way (infrared, bluetooth and so on).

The mobile, first data storage device 300 which was written with the desired data may be taken from the location of the second stationary device 200b to the location of the first stationary device 200a.

The mobile, first data storage device 300 is connected there for data transmission with the first data encryption adapter 100a (plugged in it, however, at least functionally coupled).

In step S1a, data transmission of the data encrypted with the second encryption algorithm takes place via the second interface 107a of the first data encryption adapter 100a to the first data encryption adapter 100a.

In step S2a, the first data encryption adapter 100a decrypts the data encrypted with the second encryption algorithm and encrypts it with the first encryption algorithm (which has become known).

In step S3a, the first data encryption adapter 100a transmits the data which was encrypted with the first encryption algorithm via the first interface 105a of the first data encryption adapter 100a to the first stationary device 200a.

Data which stands for, e.g., a certain credit of power quota of a household may now be filed on the power meter (corresponds to the first stationary device 200a).

Regarding the example of FIG. 7, it should be noted that the method as described there is also executable by means of only one data encryption adapter 100. For this, the data could be encrypted at the top-up station 200b already by means of the second encryption algorithm (not having become known to the public). Re-encryption such as shown in the left half of FIG. 7 may thereby advantageously be omitted. In addition, in doing so, it may also suffice to use only the data encryption adapter 100a shown in FIG. 7 and not also the data encryption adapter 100b.

Reference numeral list

| Reference numeral | Description |
|---|---|
| 100, 100a, 100b | data encryption adapters |
| 101 | first area |
| 103 | second area |
| 105, 105a, 105b | first interface |
| 107, 107a, 107b | second interface |
| 200, 200a, 200b | stationary device |
| 201 | intake area |
| 203 | blocking device |
| 205 | insertion opening |
| 300 | mobile, first data storage device |
| 1 | first device for locking |
| 3 | second device for locking |
| 5 | mounting |
| 31 | tipping axis |
| S1, S1a, S1b | method steps |
| S2, S2a, S2b | |
| S3, S3a, S3b | |

1. A method for the encrypted transmission of data from a mobile, first data storage device (300) to a stationary device (200, 200a),
which comprises a second data storage device or a second data evaluation unit,
or for preparing an encrypted transmission between the mobile, first data storage device (300) and the stationary device (200, 200a),
wherein the method comprises at least the following steps:
connecting a data encryption adapter (100, 100a) with the stationary device (200, 200a),
wherein the data encryption adapter (100, 100a) comprises a first interface (105, 105a) which is configured for the encrypted exchange or transmission of data which is encrypted by means of a first encryption algorithm with the second data storage device or a second data evaluation unit of the stationary device (200, 200a),
wherein the data encryption adapter (100, 100a) is provided and/or configured and/or designed for intaking the mobile, first data storage device (300) and/or for data transmission with the mobile, first data storage device (300),
and wherein the data encryption adapter (100, 100a) comprises a second interface (107, 107a) which is provided for exchanging data which was encrypted by means of a second encryption algorithm with the mobile, first data storage device (300);
wherein connecting the data encryption adapter (100, 100a) with the stationary device (200, 200a) encompasses establishing a data exchange connection between the data encryption adapter (100, 100a) and the second data storage device or the second data evaluation unit of the stationary device (200, 200a) for data which was encrypted by means of a first encryption algorithm.

2. The method according to claim 1, wherein the established connection of the electronic data encryption adapter (100, 100a) with the stationary device (200, 200a) is permanent.

3. The method according to claim 2, wherein the established connection takes place by including an insertion opening (205) which is provided for a mobile data storage device, or exclusively by means of it.

4. The method according to claim 1, with the step:
writing data which is encrypted by means of the second encryption algorithm on the mobile, first data storage device (300) by means of a second stationary or non-stationary device (200, 200b) which is not the first stationary device with the second data storage device or the second data evaluation unit.

5. The method according to claim 1, wherein the second data storage device or the second data evaluation unit is an electronic power meter, a water meter, or a gas meter, or wherein the second data storage device or the second data evaluation unit is provided in or at an electronic power meter, a water meter, or a gas meter.

6. A data encryption adapter (100, 100a, 100b) with at least one first interface (105, 105a, 105b) and a second interface (107, 107a, 107b), suitable and/or provided and/or configured for use in one of the methods according to claim 1.

7. The data encryption adapter (100, 100a) for being connected with a stationary device (200, 200a), wherein the data encryption adapter (100, 100a) comprises a first interface (105, 105a),
wherein the first interface is provided and/or configured for encrypted exchange or transmission of data which is encrypted by means of a first encryption algorithm with or to the second data storage device or a second data evaluation unit of the stationary device (200, 200a),
wherein the data encryption adapter (100, 100a) is provided and/or configured and/or designed for intaking the mobile, first data storage device (300) or for data transmission with the mobile, first data storage device (300) by means of a first encryption algorithm,
and wherein the data encryption adapter (100, 100a) comprises a second interface (107, 107a) which is provided for receiving data which was encrypted by means of a second encryption algorithm from the mobile, first data storage device (300).

8. The data encryption adapter (100, 100a, 100b) according to claim 7 which comprises a device which is provided and/or configured for converting the data which was encrypted by means of the first encryption algorithm, into data which is or will be encrypted by means of the second encryption algorithm, and/or vice versa.

9. The data encryption adapter (100, 100a) according to claim 8 which comprises a device (1) for its permanent locking and/or otherwise connection in or at the stationary device (200, 200a).

10. The data encryption adapter (100, 100a, 100b) according to claim 9 which comprises a device (3) for its exclusive or supportive permanent locking and/or otherwise connection in an insertion opening (205) of the stationary device (200, 200a) which is provided for a mobile, first data storage device (300).

11. The data encryption adapter (100, 100a) according to claim 10, wherein the device (1) for its connection or locking in or with the stationary device (200, 200a) is a clamping device, a latching device, a snapping device, a (barbed) hook device, a clamping device or the like.

12. The data encryption adapter (100, 100a) according to claim 7, wherein the device (1) for connecting or locking is detachable from the stationary device (200, 200a) only in a destructive way after its being connected or locked as intended.

13. The data encryption adapter (100, 100a) according to claim 7,
wherein the first interface (105, 105a) is provided and/or configured for exchanging data which is encrypted by means of a first encryption algorithm with the second data storage device or a second data evaluation unit of the stationary device (200, 200a), in particular in an encrypted way,
and wherein the second interface (107, 107a) is provided and/or configured for receiving data which is encrypted by means of a second encryption algorithm from a different data storage device than the second data storage device or a second data evaluation unit of the stationary device (200, 200a).

14. The data encryption adapter (100, 100a, 100b) according to claim 7, provided and/or designed for data transmission with a mobile, first data storage device (300) which is embodied as a SIM card or SD card.

15. The data encryption adapter (100, 100a) according to claim 7 which comprises a device (1) for its permanent locking and/or otherwise connection in or at the stationary device (200, 200a).

16. The data encryption adapter (100, 100a, 100b) according to claim 15 which comprises a device (3) for its exclusive or supportive permanent locking and/or otherwise connection in an insertion opening (205) of the stationary device (200, 200a) which is provided for a mobile, first data storage device (300).

17. The data encryption adapter (100, 100a, 100b) according to claim 7 which comprises a device (3) for its exclusive or supportive permanent locking and/or otherwise connection in an insertion opening (205) of the stationary device (200, 200a) which is provided for a mobile, first data storage device (300).

18. The data encryption adapter (100, 100a, 100b) according to claim 8 which comprises a device (3) for its exclusive or supportive permanent locking and/or otherwise connection in an insertion opening (205) of the stationary device (200, 200a) which is provided for a mobile, first data storage device (300).

19. The data encryption adapter (100, 100a) according to claim 9, wherein the device (1) for its connection or locking in or with the stationary device (200, 200a) is a clamping device, a latching device, a snapping device, a (barbed) hook device, a clamping device or the like.

20. The method according to claim 1, wherein the established connection takes place by including an insertion opening (205) which is provided for a mobile data storage device, or exclusively by means of it.
